(19) United States
(12) Patent Application Publication
(10) Pub. No.: US 2024/0364834 A1
(43) Pub. Date: Oct. 31, 2024

(54) IMAGE FORMING DEVICE

(71) Applicant: BROTHER KOGYO KABUSHIKI KAISHA, Nagoya (JP)

(72) Inventor: Kazuki ICHIKAWA, Gamagori (JP)

(21) Appl. No.: 18/644,318

(22) Filed: Apr. 24, 2024

(30) Foreign Application Priority Data
Apr. 28, 2023 (JP) 2023-074083

(51) Int. Cl. H04N 1/44; H04N 1/00

(52) U.S. Cl. CPC H04N 1/4433; H04N 1/00241; H04N 1/00413; H04N 1/00464; H04N 1/4413; H04N 2201/0094

(57) ABSTRACT

An image forming device includes a controller. The controller is configured to perform a login process of permitting a login operation performed by an administrator, and in a case where the administrator logs in, perform a data providing process of providing the browser with Web page data for displaying a Web page corresponding to an administrator operation. In a case where the administrator logs in, the controller is configured to perform a designation process of receiving designation of a permitted user who is permitted to perform a part of the administrator operation. In a case where the controller receives an instruction from the browser, the controller is configured to perform a process corresponding to the received instruction, the instruction corresponding to the part of the administrator operation received by a Web page for receiving the part of the administrator operation.

### REFERENCE TO RELATED APPLICATIONS

This application claims priority from Japanese Patent Application No. 2023-074083 filed on Apr. 28, 2023. The entire content of the priority application is incorporated herein by reference.

### BACKGROUND ART

JP2022-103244A describes an image forming device configured to receive a login operation by an administrator and configured to perform a process permitted only to the administrator.

The image forming device described in JP2022-103244A does not receive a login operation by a user other than the administrator. Therefore, it is impossible to set execution permission for a specific process to the user other than the administrator. On the other hand, in a case where all users are permitted to perform the login operation, an unspecified user is permitted to perform the process permitted only to the administrator, and thus there is a concern that security may become low.

### SUMMARY

An object of the present disclosure is to provide an image forming device for improving user convenience and for keeping security from becoming low.

An image forming device including a user interface, a communication interface, a controller, and an image forming unit. The controller is configured to function as a Web server. the controller is configured to perform a login process of permitting a login operation performed by an administrator with respect to the image forming device, the controller is configured to perform a data providing process of providing the browser with Web page data for displaying a Web page corresponding to an administrator operation with respect to the Web page displayed by the browser, according to the administrator operation. in a case where the administrator logs in, the controller is configured to perform a designation process of receiving designation of a permitted user who is permitted to perform a part of the administrator operation, in the data providing process, in a case where the permitted user logs in, Web page data that displays a Web page for receiving the part of the administrator operation is provided to the browser. In a case where the controller receives an instruction from the browser, the controller is configured to perform a process corresponding to the received instruction, the instruction corresponding to the administrator operation received by the Web page for receiving the part of the administrator operation.

An image forming device including a user interface, a communication interface, a controller, and an image forming unit. The controller is configured to perform a login process of permitting a login operation performed by an administrator with respect to the image forming device. The controller is configured to perform a data providing process of providing a browser of a terminal with Web page data for displaying a Web page corresponding to an administrator operation with respect to a Web page displayed by the browser. The controller is configured to perform a designation process of receiving designation of a permitted user who is permitted to perform a part of the administrator operation, via an operation with respect to the Web page displayed on the browser, and of storing information indicating the permitted user who is designated in a memory. Web page data that displays a Web page for only receiving the part of the administrator operation is provided to the browser, according to a request from the browser. In a case where the controller receives an instruction from the browser, the instruction corresponding to the administrator operation received by the Web page for receiving the part of the administrator operation corresponding to the administrator operation, the controller is configured to perform a process corresponding to the received instruction.

An image forming device including a user interface, a communication interface, a controller, and an image forming unit. The controller is configured to perform a login process of permitting a login operation performed by an administrator with respect to the image forming device The controller is configured to perform a data providing process of providing a browser of a terminal with Web page data for displaying a Web page corresponding to an administrator operation with respect to a Web page displayed by the browser. The controller is configured to perform a designation process of receiving designation of a permitted user who is permitted to perform a part of the administrator operation and of receiving an operation of designating whether any administrator operation among a plurality of the administrator operations is permitted. Web page data that displays a Web page for receiving the part of the administrator operation is provided to the browser. In a case where the controller receives an instruction from the browser, the instruction corresponding to the administrator operation received by the Web page for receiving the part of the administrator operation, the controller is configured to perform a process corresponding to the received instruction corresponding to the administrator operation In a case where the Web page data for receiving only the part of the administrator operation is provided, the controller is configured to determine to use a first method or a second method.

### BRIEF DESCRIPTION OF DRAWINGS

FIG. 1 is a block diagram of an MFP.

FIG. 2 is a timing chart illustrating processes that are executed between a controller and a browser.

FIG. 3 is a diagram illustrating a home screen displayed on the browser before a login operation.

FIG. 4 is a diagram illustrating a home screen displayed on the browser after the login operation.

FIG. 5 is a flowchart illustrating procedures of a process related to setting of a Web page.

FIG. 6 is a flowchart illustrating procedures of a process performed in step S10 of FIG. 5.

FIG. 7 is a diagram illustrating a page element table.

FIG. 8 is a flowchart illustrating procedures of a process performed in step S15 of FIG. 5.

FIG. 9 is a diagram illustrating the home screen displayed on the browser after the login operation.

FIG. 10 is a diagram illustrating a Web page displayed on the browser.

FIG. 11 is a flowchart illustrating procedures of a process at the time of setting an account.

FIG. 12 is a diagram illustrating a home screen displayed on the browser after the login operation.

FIG. 13 is a diagram illustrating a Web page displayed on the browser.

FIG. 14 is a diagram illustrating a home screen displayed on the browser after the login operation.

### DESCRIPTION

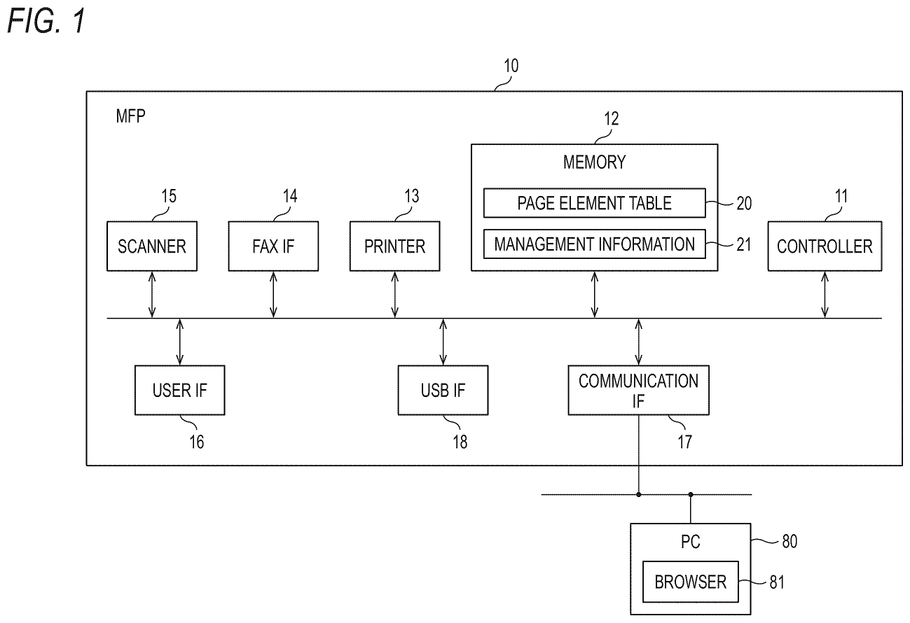

An image forming device according to the present embodiment will be described by using a multifunction peripheral (MFP) as an example. An MFP 10 shown in FIG. 1 is connected to a network and configured to communicate with a PC 80 via the network. The network is a LAN or the Internet. The Internet may be either a wired connection or a wireless connection. The network may be a USB cable that connects the MFP 10 and the PC 80.

The MFP 10 includes a controller 11, a memory 12, a printer 13, a FAX IF 14, a scanner 15, a user IF 16, a communication IF 17, and a USB IF 18. These units are connected to a bus and configured to communicate with one another. Further, the word “IF” is an abbreviation of Interface.

The user IF 16 is an interface interposed between the controller 11 and a user who directly operates the MFP 10. The user IF 16 includes a touch panel and an operation key that is a physical key, for example. The communication IF 17 is an interface for connecting the MFP 10 to the network. The printer 13 is configured to print an image on a recording medium such as a sheet or a disk. As a recording method of the printer 13, an ink jet method, an electrophotographic method, or the like can be adopted. The scanner 15 is configured to read a document and configured to generate scan data. The MFP 10 may be configured to perform a combined operation obtained by combining a plurality of operations, such as a combination of an operation of generating the scan data and an operation of printing. In the present embodiment, the printer 13 and the scanner 15 are examples of an image forming unit.

The USB IF 18 is an interface configured to perform communication conforming to a universal serial bus (USB) standard. The USB standard is not particularly limited, and USB 2.0 standard, USB 3.0 standard, or the like can be adopted. A device connected to the USB IF 18 may be a portable type device such as a USB memory, and may be a USB connectable HDD. For example, the device may be a memory card configured to communicate with the MFP 10, via a card reader connected to the USB IF 18.

The controller 11 includes a CPU, an application specific integrated circuit (ASIC), and the like. The memory 12 may include a RAM, a ROM, an SSD, an HDD, and the like. A buffer that is provided in the controller 11 and that is used when various programs are executed may also be regarded as a part of the memory 12. The memory 12 may be a storage medium configured to be read by the controller 11. The storage medium configured to be read by the controller 11 is a non-transitory medium. The non-transitory medium also includes a recording medium such as a CD-ROM or a DVD-ROM, in addition to the examples described above. The non-transitory medium is also a tangible medium. On the other hand, an electric signal carrying a program downloaded from a server or the like on the Internet is a computer-readable signal medium, which is a kind of computer-readable medium, but is not included in the non-transitory computer-readable storage medium.

The memory 12 is configured to store firmware as a program to be executed by the controller 11. The present embodiment mainly describes a process of the controller 11 according to a command written in the program. That is, processes such as “judgment”, “selection”, “calculation”, “determination”, “specification”, “acquisition”, “reception”, and “control” to be described below represent processes of the controller 11. The process “acquisition” is used as a concept indicating that a request is not essential. That is, a process of receiving data without a request from the controller 11 is also included in a concept indicating that “the controller 11 acquires data”. Further, the term “data” in the present specification is represented by a controller-readable bit string. Data having substantially the same meaning and different formats are regarded as the same data. The same applies to “information” in the present specification.

The controller 11 also functions as a Web server for displaying a predetermined Web page on the PC 80 by performing the firmware. The controller 11 is configured to cause a browser 81 to be described later of the PC 80 to display the Web page by transmitting, to the PC 80, Web page data for displaying the Web page.

Next, a configuration of the PC 80 will be described. The PC 80 includes a communication IF, a memory, a controller, a display, and a user IF which are not shown. The memory of the PC 80 is configured to store an OS and the browser 81. The browser 81 is an abbreviation of a browser program. The controller of the PC 80 is configured to operate, in accordance with the browser 81, to cause the display to display the Web page corresponding to the Web page data transmitted from the MFP 10. In the present embodiment, the Web page that the controller 11, as the web server, causes the browser 81 of the PC 80 to display, and the PC 80 that displays this Web page are also examples of the user IF. A terminal is not limited to the PC 80 and may be a portable terminal such as a smartphone as long as the terminal is a device configured to perform wireless communication with the MFP 10 via a network.

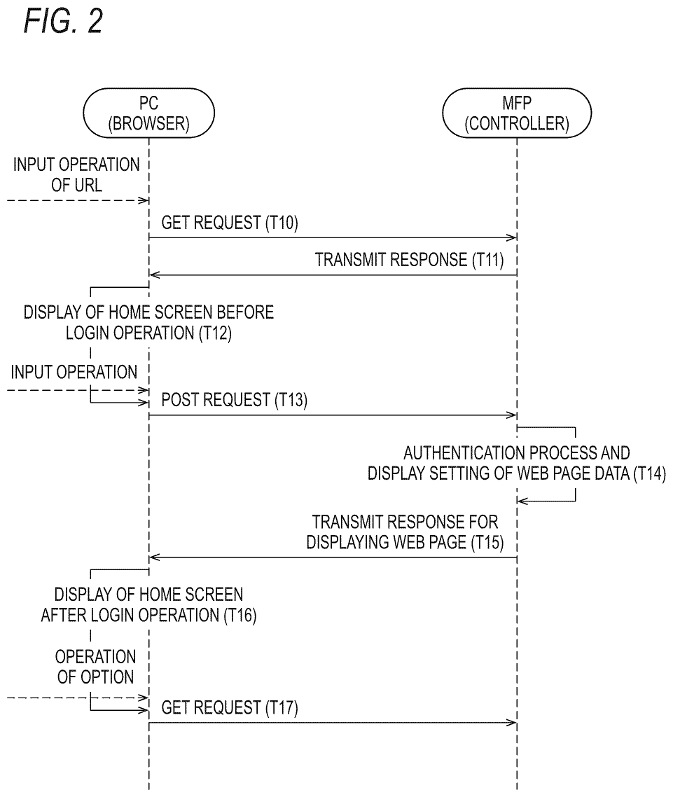

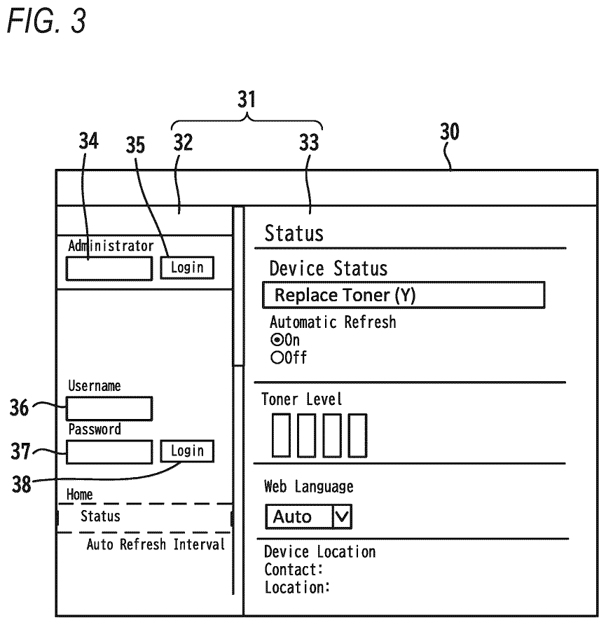

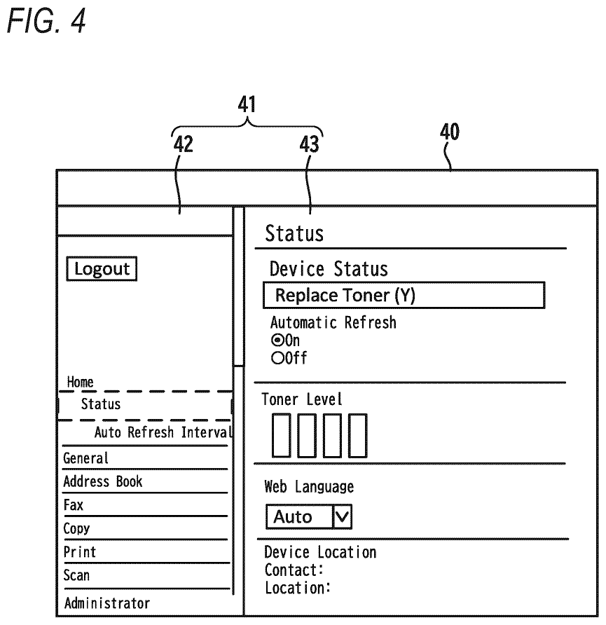

Next, procedures of a process when the controller 11 of the MFP 10 functions as the Web server to cause the browser 81 of the PC 80 to display the Web page will be described with reference to FIG. 2. That is, the controller 11 is configured to supply Web page data to the browser 81 of the PC 80 to display Web pages shown in FIGS. 3 and 4, which will be described later, and is configured to receive various instructions with respect to the MFP 10 by operations on the Web pages.

The user operates the PC 80 to input, to the browser 81, a URL for specifying the Web server of the MFP 10. The browser 81 is configured to transmit a GET request for HTTPS communication including the input URL, at a timing 10 (hereinafter, the timing is also referred to as “T”). Upon receiving the GET request from the browser 81, the controller 11 transmits an HTTPS response corresponding to the GET request.

The response returned at T11 includes the Web page data for displaying a home screen 30 before a login operation shown in FIG. 3. Upon receiving the Web page data, the browser 81 cause the display to display the home screen 30 before the login operation, by using the Web page data at T12.

The home screen 30 shown in FIG. 3 includes a page display field 31 including a menu 32 and a content display portion 33. In the menu 32, tabs for receiving selection operations of various functions of the MFP 10 are displayed. In addition, the home screen 30 may include a URL display field for displaying a URL of a registration site above the page display field 31. In this example, a state where the user selects and operates an option “Status” belonging to a tab “Home” in the menu 32 on the home screen 30 before the login operation, is displayed. The option “Status” has a function indicating a state of the MFP 10 at a current time point and setting contents. The tabs and the option will be described in detail later. The content display portion 33 includes, as a status of the MFP 10, an object for designating an enabling state of an “on” state of “Automatic Refresh” and a disabling state of an “off” state of “Automatic Refresh”, an object for indicating a remaining amount of a toner, an object for receiving a setting for a language to be displayed on the Web page, and the like. In the present embodiment, components included in a Web page such as texts, buttons, icons, and input fields are collectively referred to as objects for convenience. Further, the objects described in the present embodiment may be replaced with other types of objects.

In a case where an administrator inputs a password, which indicates administrator information, in an administrator password input field 34 displayed in the menu 32 and operates an administrator login button 35 with respect to the home screen 30 before the login operation, the browser 81 transmits, to the controller 11, information indicating that the administrator login button 35 is operated, and a POST request including the password, at T13. Upon receiving the POST request including the password, the controller 11 performs an authentication process using the password included in the POST request and display setting of Web page data corresponding to an authority of a login user at T14. In the present embodiment, the password input in the administrator password input field 34 is an example of the administrator information. The process performed by the controller 11 at T14 is an example of a data providing process.

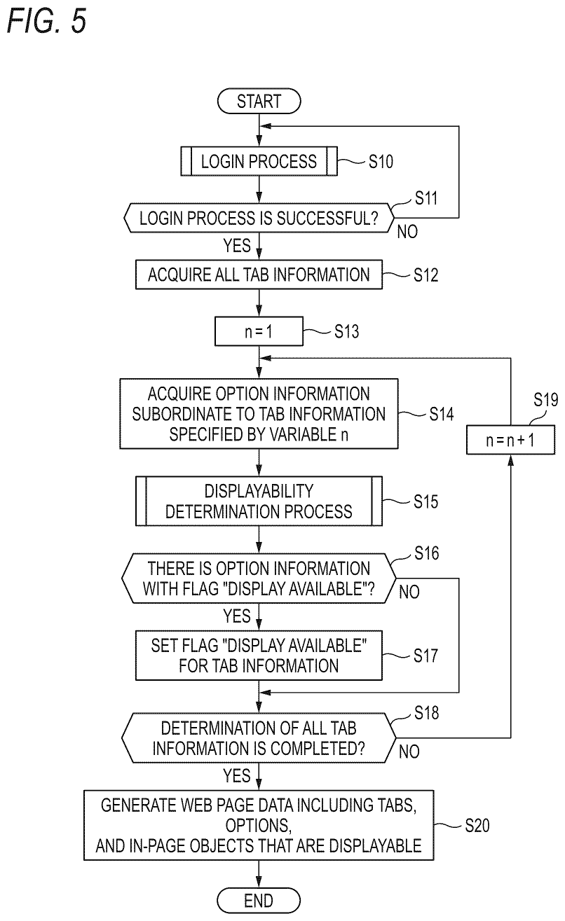

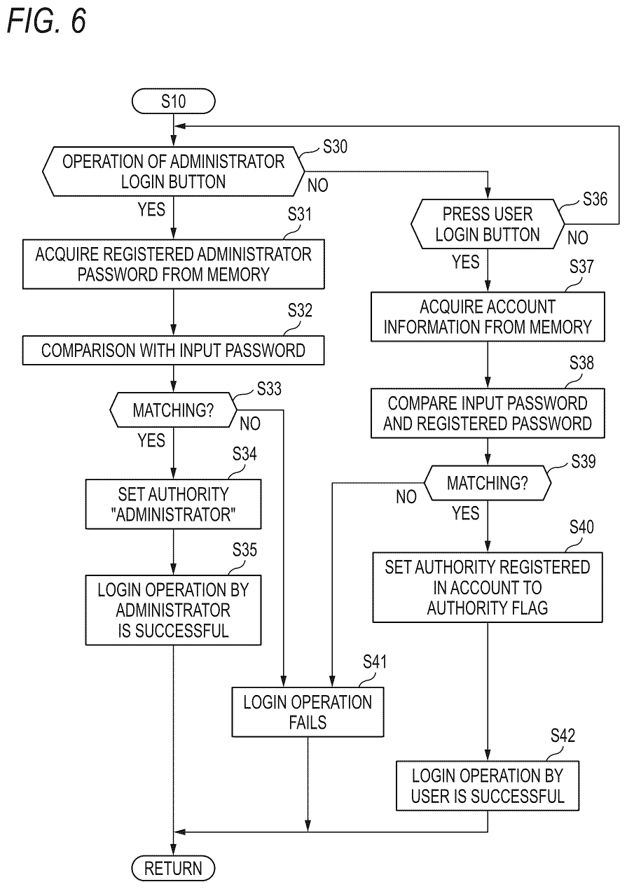

FIG. 5 is a flowchart illustrating details of the process executed by the controller 11 at T14. First, the controller 11 performs a login process using the password included in the POST request in step S10 (hereinafter, the step is also referred to as “S”). FIG. 6 is a flowchart illustrating details of the login process executed by the controller 11 in step S10.

In step S30, the controller 11 determines whether the administrator login button 35 is operated. Specifically, the controller 11 determines whether information indicating that the administrator login button 35 is operated is included in the POST request. In this example, since the administrator operates the administrator login button 35 (step S30: YES), the process proceeds to step S31, and a registered administrator password is acquired from the memory 12. The registered administrator password is a password used for authentication of the login operation by the administrator, and is registered in the memory 12 at the time of factory shipment in the present embodiment. The administrator can also change the registered administrator password registered in the memory 12.

In step S32, the controller 11 compares the password included in the POST request with the acquired registered administrator password. In a case where the controller 11 determines that a result of the password comparison in step S32 indicates matching (step S33: YES), the process proceeds to step S34, and the controller 11 sets an authority flag indicating that an authority of the login user is “administrator”. In the present embodiment, for convenience, the administrator is also described as a type of the login user, but a configuration in which the administrator and the user are clearly different persons is not excluded. The authority flag is information indicating the authority of the login user, and the authority “administrator” indicates that the login user is the administrator. The authority flag retains a value when the administrator is in a login state, and is deleted when the administrator logs out. When the password and the registered administrator password partially match with each other as the comparison result in step S32, the controller 11 may permit the login operation.

In step S35, the controller 11 sets that the login operation by the administrator is successful, and the process proceeds to step S11 of FIG. 5. In a case where the password included in the POST request does not match the registered administrator password in step S33 (step S33: NO), the process proceeds to step S41, and the controller 11 notifies the PC 80 of failure in the login operation. Specifically, the controller 11 transmits, to the PC 80, data for displaying a Web page indicating that the login operation fails. The browser 81 of the PC 80 uses the received data to display a notification screen indicating that the login operation by the administrator fails.

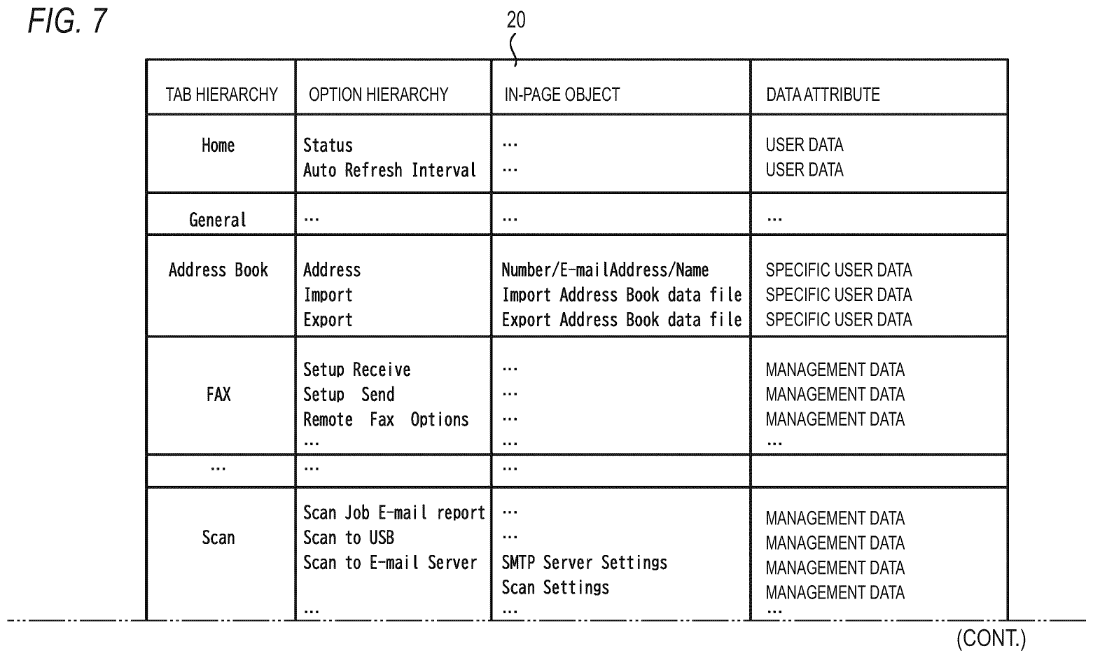

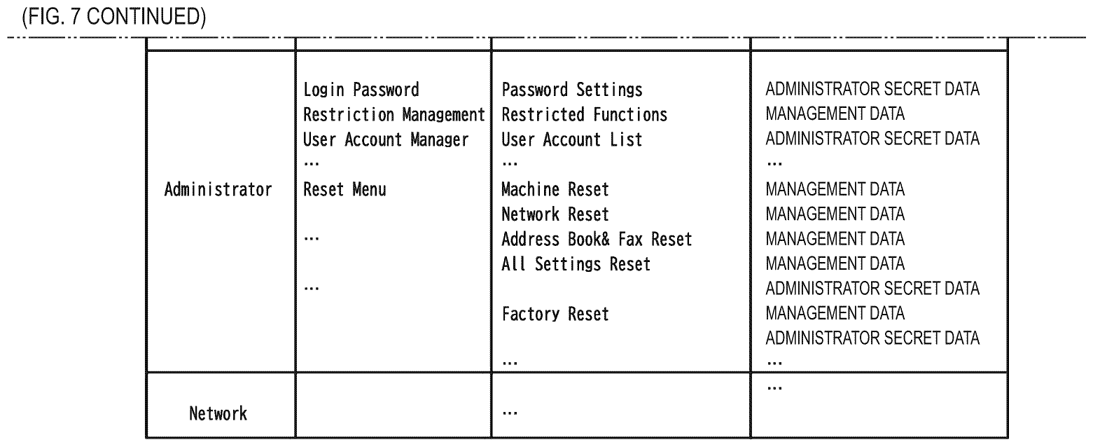

Since the login process is successful in step S11 of FIG. 5 (step S11: YES), the process proceeds to step S12, and the controller 11 acquires information related to a Web page constituting a site after the login operation from a page element table 20 stored in the memory 12. Here, after the login operation by the administrator, a home screen 40 after the login operation, which is the Web page shown in FIG. 4, is displayed. FIG. 7 is a diagram illustrating the page element table 20 stored in the memory 12.

The Web page data that can be provided by the controller 11 is configured to have a hierarchical structure including a tab hierarchy and a menu hierarchy. Here, the tab hierarchy forms the highest hierarchy in the hierarchical structure. The page element table 20 shown in FIG. 7 includes, as information indicating elements of the tab hierarchy, information including “Home”, “General”, “Address Book”, “Fax”, “Copy”, “Print”, “Scan”, “Administrator”, and “Network”. In the page element table 20, the information indicating the elements of the tab hierarchy refers to information corresponding to respective tabs displayed in a menu 42. In the following description, the elements of the tab hierarchy registered in the page element table 20 are referred to as tab information, and objects displayed in the menu of the Web page are referred to as tabs, to distinguish the two.

The menu hierarchy is a hierarchy subordinate to the tab hierarchy. In the page element table 20 shown in FIG. 7, elements of the menu hierarchy such as “Login Password”, “Restriction Management”, “User Account Manager”, and “Reset Menu” are subordinate to the tab information “Administrator”. In the page element table 20, information indicating the elements of the menu hierarchy refers to information corresponding to respective options displayed in the menu 42. Here, the element “Login Password” indicates a function related to a login function of the MFP 10. The element “Restriction Management” indicates a function related to restriction setting of functions executable by the MFP 10. The element “User Account Manager” indicates a function related to setting of account information, which will be described later. The element “Reset Menu” indicates a function related to resetting of various settings of the MFP 10. In the following description, the elements of the menu hierarchy registered in the page element table 20 are referred to as option information, and objects displayed in the menu of the Web page are referred to as options to distinguish the two.

The Web page is configured based on the tab information and the option information described above. Specifically, as described later, the tab information and the option information are displayed as the objects (the tabs, the option) in the menu 42 of the Web page while maintaining the hierarchical structure. The tabs and the options may be objects having a text feature and an icon feature. In a case where one of the tabs displayed in the menu 42 is operated, the option corresponding to the option information that is subordinate to the corresponding tab information is displayed in the page element table 20. In a case where one of the options displayed in the menu 42 is operated, the browser 81 designates a link destination (a URL) to the Web page data associated with the corresponding option information and requests the controller 11 for the Web page data.

For example, in a case where an option that is subordinate to the tab “FAX” displayed in the menu 42 is selected and operated, the controller 11 provides, to the PC 80, Web page data for displaying a Web page corresponding to registration of a setting value related to FAX communication, according to a request from the browser 81. Upon receiving a POST request including information that specifies the setting value designated by an operation via the Web page displayed by the browser 81, the controller 11 stores the designated setting value in the memory 12. For example, in a case where an option subordinate to the tab “Scan” displayed in the menu 42 is selected and operated, the controller 11 provides, to the PC 80, Web page data for displaying a Web page corresponding to registration of a setting value related to scan, according to a request from the browser 81. Upon receiving a POST request including information that specifies the setting value designated by an operation via the Web page displayed by the browser 81, the controller 11 stores the designated setting value in the memory 12.

Although not shown, in the page element table 20, the tab information “Print” and the option information subordinate to the tab information “Print”, which correspond to provision of a Web page for registering a setting value related to print as an operation of the MFP 10, may be registered. In the page element table 20, the tab information “Copy” and the option information subordinate to the tab information “Copy”, which correspond to provision of a Web page for registering a setting value related to copy as an operation of the MFP 10, may be registered.

In the present embodiment, an operation executed by operating a tab other than the tab “Home” and an option subordinate to the tab displayed in the menu 42 on the home screen 40 after the login operation is an example of the administrator operation. Specifically, an operation executed by operating one of the tabs “General”, “Address Book”, “Fax”, “Copy”, “Print”, “Scan”, “Administrator”, and “Network” and an option subordinate to the tab is an example of the administrator operation.

An in-page object refers to information corresponding to an object constituting a Web page (strictly, a content display portion) specified by the option information. In the page element table 20 shown in FIG. 7, an in-page object “Password Setting” is subordinate to the option information “Login Password”. Therefore, in a case where the user operates the option “Login Password” displayed in the menu 42, an object specified by the in-page object “Password Settings” can be displayed on a content display portion 43. The number of objects indicated by one in-page object is not limited to one, and a plurality of objects may be indicated.

Returning to FIG. 5, in step S12, the controller 11 acquires the tab information “Home”, “General”, “Address Book”, “Fax”, “Copy”, “Print”, “Scan”, “Administrator”, and “Network” included in the tab hierarchy, from the page element table 20 stored in the memory 12. The tab information acquired in step S12 refers to all the tab information registered in the page element table 20.

In step S13, the controller 11 sets a variable n corresponding to a tab number for specifying the tab information to “1”. The tab number is a number for specifying the tab information, and is registered in association with the tab information in the page element table 20 described above. The “n” is a variable, and in the present embodiment, the variables n including “1”, “2”, “3”, “4”, “5”, “6”, “7”, “8”, and “9” are respectively associated with the tab information “Home”, “General”, “Address Book”, “Fax”, “Copy”, “Print”, “Scan”, “Administrator”, and “Network” in this order.

In step S14, the controller 11 acquires the option information subordinate to the tab information “Home” specified by the tab number “1”, with reference to the page element table 20. In this example, since the option information “Status” and option information “Auto Refresh Interval” are subordinate to the tab information “Home” specified by the tab number “1”, the controller 11 acquires the option information “Status” and option information “Auto Refresh Interval” from the page element table 20. Hereinafter, the tab information specified by using the tab number is also referred to as “specified tab information”. Similarly, the option information specified by using the tab number and an option number to be described later is also referred to as “specified option information”.

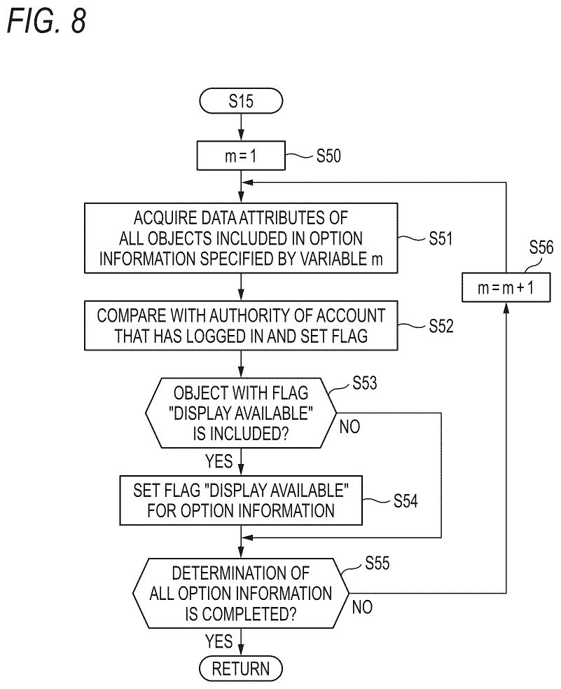

In step S15, the controller 11 performs a displayability determination process of determining whether the object corresponding to the in-page object included in the option information acquired in step S14 is to be displayed or non-displayed. FIG. 8 is a flowchart illustrating details of the process executed by the controller 11 in step S15.

In step S50, the controller 11 sets, to “1”, a variable m corresponding to the option number for specifying the option information acquired in step S14. The option number is a number for specifying the option information, and is registered in association with the option information in the page element table 20 described above. The “m” is a variable. The option number refers to continuous values with respect to the option information subordinate to the tab information as one group. For example, in the option information subordinate to the tab information “Home” specified by the tab number “1”, an option number “1” corresponds to the option information “Status”, and an option number “2” corresponds to the option information “Auto Refresh Interval”.

In step S51, the controller 11 acquires data attributes for all in-page objects included in the specified option information at a current time point. The data attribute refers to information indicating which one among the authority “administrator”, an authority “sub-administrator”, and an authority “specific user” is allowed to access the in-page object. In the page element table 20 shown in FIG. 7, any of data attributes “administrator secret data”, “management data”, “specific user data”, and “user data” is associated with the in-page object. In the page element table 20, in a case where one in-page object includes a plurality of objects, a plurality of data attributes may be associated with the in-page object.

The data attribute “administrator secret data” refers to an attribute indicating that the login user can access to the in-page object only in a case where the authority flag is set to the authority “administrator”. The data attribute “management data” refers to an attribute indicating that the login user can access to the in-page object in a case where the authority flag is set to the authority “administrator” or the authority “sub-administrator”. The data attribute “specific user data” refers to an attribute indicating that the login user can access to the in-page object in a case where the authority flag is set to the authority “administrator” or the authority “specific user”. The data attribute “user data” refers to an attribute indicating that all users can access to the in-page object, that is, in a state of not logging in. The setting of the authority flag to the authority “administrator” is executed in step S34 of FIG. 6 in the login process described above. The setting of the authority flag to the authority “sub-administrator” or the authority “specific user” will be described later.

In step S52, the controller 11 compares an authority of an account that has logged in with a data attribute associated with the specified in-page object at the current time point, and sets an object display flag indicating “display available” or “display unavailable” for each in-page object, according to a result of the comparison. Specifically, in a case where the authority of the user who has logged in is higher than the data attribute associated with the specified in-page object at the current time point, the object display flag “display available” is set for the specified in-page object at the current time point. On the other hand, in a case where the authority of the user who has logged in is lower than the data attribute associated with the specified in-page object at the current time point, the object display flag “display unavailable” is set for the specified in-page object at the current time point. In this example, since the administrator logs in, the authority flag is set to the “administrator” having the highest authority, and the object display flag “display available” is set for all the specified objects.

In step S53, the controller 11 determines whether the object for which the object display flag “display available” is set is included in the specified in-page object at the current time point, according to the process in step S52. In this example, since the authority flag is the “administrator”, the “display available” is set for all the specified in-page objects (step S53: YES), the process proceeds to step S54, and the controller 11 sets an option display flag “display available” for the option information specified by the option number at a current time point.

In step S55, the controller 11 determines whether the processes in step S51 to step S54 are executed with respect to all the option information subordinate to the specified tab information at the current time point. Specifically, the controller 11 determines whether a value of the variable m corresponding to the option number is equal to the total number of options subordinate to the specified tab at the current time point. In this example, since the processes in step S51 to step S54 are not executed with respect to all the option information subordinate to the specified tab information at the current time point (that is, the tab specified by the variable n “1”) (step S55: NO), the process proceeds to step S56, and the controller 11 increases the variable m corresponding to the option number by only 1, and changes the option information to be specified. Then, the process proceeds to step S51, and the controller 11 sets the object display flag for all the in-page objects included in the newly specified option information by the processes in step S51 and step S52 described above. Then, the controller 11 sets the option display flag by the processes in step S51 to step S54 described above.

In a case where the controller 11 executes the processes in step S51 to step S54 with respect to all the option information subordinate to the specified tab information at the current time point (in this example, the tab information specified by the variable n “1”) (step S54: YES), the process proceeds to step S16 of FIG. 5.

In step S16, the controller 11 determines whether the option information for which the option display flag “display available” is set is included in the option information subordinate to the specified tab information at the current time point. In this example, since the option display flag “display available” is set for all the option information subordinate to the specified tab information at the current time point (step S16: YES), the process proceeds to step S17, and the controller 11 sets the tab display flag “display available” to the specified tab information at the current time point.

In step S18, the controller 11 determines whether the setting of the tab display flag in step S17 is executed with respect to all the tab information registered in the page element table 20. Specifically, the controller 11 determines whether a value of the variable n is equal to the total number of pieces of tab information. Here, since the setting of the tab display flag in step S17 is not executed with respect to all the tab information (step S18: NO), the process proceeds to step S19, and the controller 11 increases the variable n corresponding to the tab number by only “1”, and changes the tab information to be specified. Then, the process proceeds to step S14, and the controller 11 acquires, from the page element table 20, the option information subordinate to the newly specified tab information (in this example, the tab information specified by the variable n “2”). Then, in step S15, the controller 11 executes the displayability determination process described above on the newly acquired option information. Thereafter, the controller 11 executes the setting of the tab display flag in step S17 described above on the newly specified tab information. Therefore, the tab information, the option information, and the in-page object are registered in the page element table 20, the tab display flag (display available or display unavailable) is set to the tab information, the option display flag (display available or display unavailable) is set to the option information, and the object display flag (display available or display unavailable) is set to the in-page object.

In a case where the controller 11 executes the process in step S17 with respect to all the tab information registered in the page element table 20 (step S18: YES), the process proceeds to step S20. In step S20, the controller 11 reflects values of the tab display flag, the option display flag, and the object display flag, and generates Web page data including tabs, options, and objects that are displayable.

Returning to FIG. 2, at T15, the controller 11 transmits a response including the Web page data generated by the process in step S20 to the PC 80. At T16, the browser 81 analyzes the Web page data included in the response, and displays the home screen 40 after the login operation shown in FIG. 4. A page display field 41, the menu 42, and the content display portion 43 included in the home screen 40 have the same configurations as the page display field 31, the menu 32, and the content display portion 33 described in FIG. 3. In this example, since the administrator logs in and the authority flag “administrator” is set, the tabs “Home”, “General”, “Address Book”, “Fax”, “Copy”, “Print”, “Scan”, “Administrator”, and “Network” corresponding to all the tab information included in the page element table 20 can be displayed in the menu 42 on the home screen 40 after the login operation.

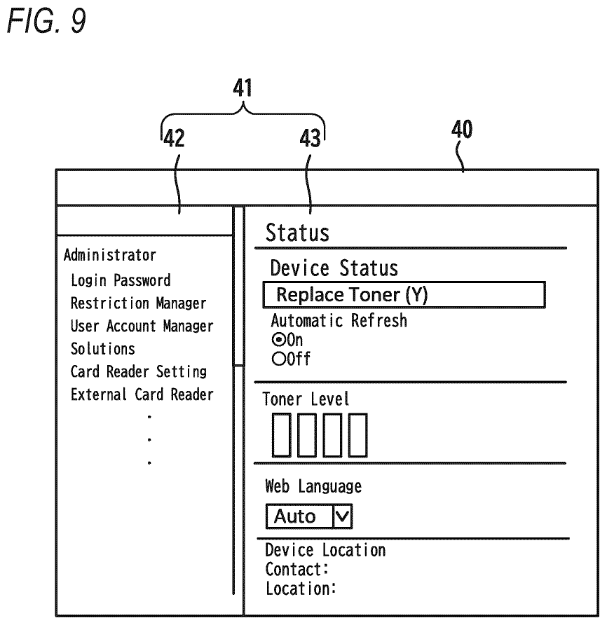

In a case where the administrator operates the tab “Administrator” in the menu 42 on the home screen 40 after the login operation, all options subordinate to the tab “Administrator” can be displayed in the menu 42, as shown in FIG. 9.

Thereafter, in a case where the user operates any option displayed in the menu 42 on the home screen 40 after the login operation, the browser 81 designates a link destination (URL) of Web page data corresponding to the selected option, and transmits a GET request for requesting the Web page data to the controller 11, at T17. Upon receiving the GET request, the controller 11 generates the Web page data corresponding to the operated option, according to the GET request. In this case, similarly to the process in step S20 described above, the controller 11 reflects the values of the tab display flag, the option display flag, and the object display flag, and generates the Web page data including tabs, options, and objects that are displayable. In the present embodiment, the processes executed by the controller 11 at T14 and T15 and a process that is executed by the controller 11 to provide Web page data according to a request from the browser 81 to be described later, are examples of the data providing process.

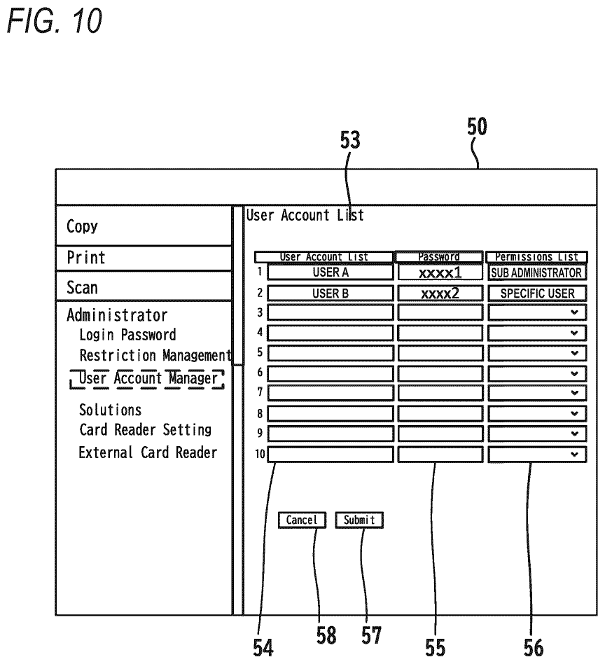

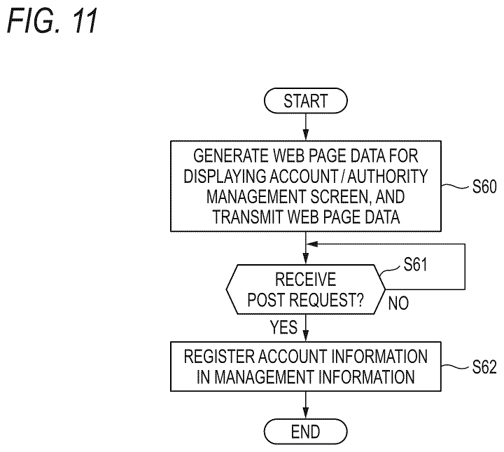

Next, as shown in FIG. 9, it is assumed that on the home screen 40 after the login operation, the administrator operates the option “User Account Manager” subordinate to the tab “Administrator” displayed in the menu 42. In a case where the option “User Account Manager” is operated on the home screen 40 after the login operation, the browser 81 transmits, to the MFP 10, a GET request that requests Web page data for displaying an account/authority management screen 50 shown in FIG. 10. Upon receiving the GET request, the controller 11 starts a process shown in FIG. 11.

In step S60, the controller 11 generates the Web page data for displaying the account/authority management screen 50 shown in FIG. 10, and transmits a response including the Web page data to the PC 80. Also in this example, since the authority flag “administrator” is set, the controller 11 generates Web page data including objects corresponding to all the in-page objects.

Upon receiving the response, the browser 81 of the PC 80 analyzes the Web page data and displays the account/authority management screen 50. The account/authority management screen 50 is a Web page for receiving registration operations of a plurality of accounts 1 to 10. On the account/authority management screen 50, a content display portion 53 includes a user input field 54, a password input field 55, and an authority input field 56, in accordance with the accounts to be registered. The user input field 54 is a field that receives an input of a user name for creating an account. The password input field 55 is a field that receives an input of a password. The authority input field 56 is a field that is capable of receiving input of one of the authority “sub-administrator” and the authority “specific user” described in the page element table 20.

In this example, it is assumed that account information indicating a user name “user A”, a password “xxxx1”, and the authority “sub-administrator” is registered as an “account 1” in management information 21 to be described later. That is, the account information is registered in the management information 21 stored in the memory 12. It is assumed that the administrator inputs a user name “user B” in the user input field 54, a password “xxxx2” in the password input field 55, and the authority “specific user” in the authority input field 56 as an “account 2”, and operates a submit button 57. In the present embodiment, the “specific user” is a user who is permitted to operate an address book managed by the MFP 10. The browser 81 transmits a POST request including the newly input account information (the user name, the password, and the authority) to the MFP 10. In a case where the administrator operates a cancel button 58, values newly input to the user input field 54, the password input field 55, and the authority input field 56 are canceled, and the account/authority management screen 50 returns to a display screen reflecting the information registered in the management information 21.

In a case where the POST request including the account information is received in step S61 (step S61: YES), the process proceeds to step S62, and the controller 11 registers the account information (the user name, the password, and the authority) included in the POST request to the management information 21 stored in the memory 12. The management information 21 refers to information for registering the account information input by using the account/authority management screen 50, and the password and the authority are registered in association with the user name. In the present embodiment, the processes executed by the controller 11 in step S60 to step S62 of FIG. 11 are examples of a designation process. The “sub-administrator” and the “specific user” are examples of a permitted user. In the present embodiment, the administrator can change a value of the registered administrator password registered in the memory 12 to the password input in the password input field 55 by inputting the authority “administrator” in the authority input field 56, by inputting the password in the password input field 55, and by operating the submit button 57.

Next, a process in a case where the home screen 30 before the login operation is operated by using the user name “user A”, which is registered by using the account/authority management screen 50, to perform the login process will be described with reference to FIGS. 2, 5, and 6. The login operation by the user other than the authority “administrator” is executed by inputting the user name in a user name input field 36 and the user password in a password input field 37 on the home screen 30 before the login operation shown in FIG. 3. As described above, the user password is a password that is stored in the memory 12 in association with the user name by the controller 11 according to the operation on the account/authority management screen 50 illustrated in FIG. 10, and is a password different from the administrator password. In a case where the user operates a user login button 38 on the home screen 30 before the login operation, the browser 81 transmits, to the MFP 10 at T13, a POST request including the user name in the user name input field 36, the password information in the password input field 37, and information indicating that the user login button 38 is operated.

In a case where the controller 11 receives the POST request and acquires the information indicating that the user login button 38 is operated from the POST request (FIG. 6, step S30: NO, step S36: YES), the process proceeds to step S37. In step S37, the controller 11 acquires the account information associated with the user name “user A”, from the management information 21 stored in the memory 12.

In step S38, the controller 11 compares the user password included in the POST request with a registered password associated with the user name “User A” in the management information 21. In a case where it is determined that a result of the password comparison indicates matching (step S39: YES), the process proceeds to step S40, and the controller 11 sets the authority (in this example, the sub-administrator) registered in the account information to the authority flag corresponding to the login user.

In step S42, the controller 11 sets that the login operation by the user is successful, and the process proceeds to step S11 of FIG. 5. In a case where the user password included in the POST request does not match the registered password associated with the registered user name “User A” in step S38 (step S39: NO), the process proceeds to step S41, and the controller 11 notifies the PC 80 of the failure in the login operation.

In step S11 of FIG. 5, since the login process is successful (step S11: YES), the process proceeds to step S12, and the controller 11 acquires the tab information in the Web page constituting the site from the page element table 20 stored in the memory 12. The tab information and the option information have already been described with reference to FIG. 7.

In step S13, the controller 11 sets the variable n corresponding to the tab number to “1”. In step S14, the controller 11 acquires the option information subordinate to the tab information “Home” that is specified by the tab number “1” with reference to the page element table 20. In step S15, as described above, the controller 11 executes the displayability determination process.

In step S52 of the displayability determination process, the controller 11 compares the authority of the account that has logged in with the data attribute associated with the specified in-page object at the current time point, and sets the object display flag indicating “display available” or “display unavailable” for each in-page object according to the result of the comparison. In this example, since the authority flag is set to the “sub-administrator”, in a case where the data attribute associated with the specified in-page object at the current time point is any one of the “management data”, the “specific user data”, and the “user data”, the controller 11 sets the object display flag “display available” for the in-page object. On the other hand, in a case where the data attribute associated with the specified in-page object at the current time point includes the “administrator secret data”, the controller 11 sets the object display flag “display unavailable” for the in-page object.

In this example, in-page objects “Password Settings”, “User Account List”, “All Settings Reset”, and “Factory Reset”, which are included in option information subordinate to the tab information “Administrator” specified by the variable n “8” corresponding to the tab number, are associated with the data attribute “administrator secret data”. The in-page objects “All Settings Reset” and “Factory Reset” are also associated with the data attribute “management data”, in addition to the data attribute “administrator secret data”. The above indicates that each of the in-page objects “All Settings Reset” and “Factory Reset” is constituted by a plurality of objects, and includes objects associated with the data attributes “administrator secret data” and “management data”.

Since the authority flag is the “sub-administrator”, the controller 11 sets the object display flag “display unavailable” for the in-page objects “Password Settings”, “User Account List”, “All Settings Reset”, and “Factory Reset” included in the option information subordinate to the specified tab information “Administrator”, in step S52 described above.

Since no in-page object for which the object display flag “display available” is set is included in the specified option information “Login Password” in step S53 described above (step S53: NO), the process proceeds to step S55 without the controller 11 setting the option display flag “display available”. That is, the controller 11 maintains the option display flag “display unavailable”. Similarly, since no in-page object for which the object display flag “display available” is set is included in the specified option information “User Account Manager” in step S53 described above (step S53: NO), the controller 11 maintains the option display flag “display unavailable”. In a case where the user other than the administrator is permitted to the “Login Password” as an object related to a setting operation of the authentication information of the administrator and the “User Account Manager” as an object related to a designation operation of the permitted user, an excessive reduction in security may occur, and thus the user is not permitted thereto. On the other hand, since the in-page object for which the object display flag “display available” is set is included in the specified option information “Restriction Management”, “Reset Menu”, or the like in step S53 described above (step S53: YES), the controller 11 sets the option display flag “display available” in step S54. In a case where the controller 11 executes the setting of the flags in step S52 and step S54 with respect to all the option information subordinate to the specified tab information at the current time point (step S55: YES), the process proceeds to step S16 in FIG. 5.

In a case where the controller 11 executes the process in step S17 with respect to all the tab information registered in the page element table 20 (step S18: YES), the process proceeds to step S20. In step S20, the controller 11 reflects the values of the tab display flag, the option display flag, and the object display flag, and generates the Web page data including tabs, options, and objects that are displayable.

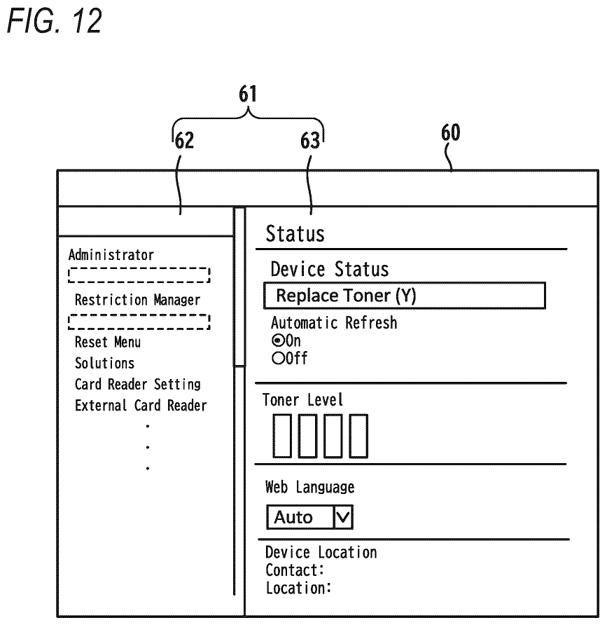

FIG. 12 illustrates a home screen 60 after the login operation, which is displayed by the browser 81 based on the Web page data created in step S20 by the controller 11 when the sub-administrator logs in. A page display field 61, a menu 62, and a content display portion 63 constituting the home screen 60 have the same configurations as the page display field 31, the menu 32, and the content display portion 33 described in FIG. 3. In this example, since the controller 11 sets the tab display flag “display available” for all the tab information registered in the page element table 20 by the process in step S17, all the tabs can be displayed in the menu 62.

On the other hand, in a case where the sub-administrator operates the tab “Administrator” displayed in the menu 62, options corresponding to the option information “Login Password” and “User Account Manager”, for which the option display flag “display unavailable” is set, among all the option information subordinate to the tab information “Administrator”, are not displayed. This is because the data attributes of the option information “Login Password” and “User Account Manager” are the “administrator secret data”, and an access authority of the “administrator secret data” is higher than that of the authority “sub-administrator”. In other words, in a case where the administrator logs in, Web page data in which the number of options is the first number is provided to the browser 81 as shown in FIG. 9, and it becomes possible to provide Web page data for displaying the first number of Web pages. On the other hand, in a case where the sub-administrator logs in, Web page data in which the number of options is the second number smaller than the first number is provided to the browser 81 as shown in FIG. 12, and it becomes possible to provide Web page data for displaying the second number of Web pages.

In a case where the option “Login Password” is selected and operated, the controller 11 provides, to the PC 80, Web page data for displaying a Web page corresponding to an operation for registering the registered administrator password. Upon receiving a POST request including the password input by the operation via the Web page displayed on the browser 81, the controller 11 updates the registered administrator password registered in the memory 12 to the password included in the POST request and registers the password.

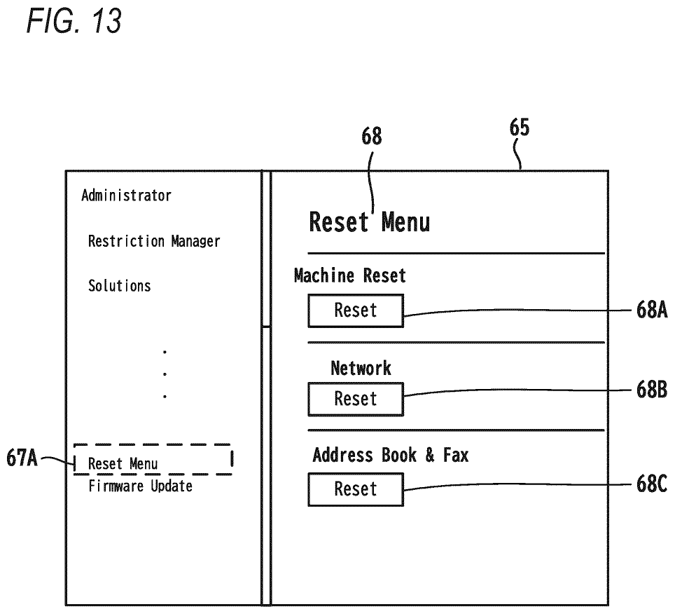

In a case where the sub-administrator operates an option “Reset Menu” 67A subordinate to the tab “Administrator”, as described above, the browser 81 displays a Web page 65 related to the option “Reset Menu” 67A shown in FIG. 13 based on the Web page data transmitted from the controller 11. The Web page 65 is a Web page for receiving various reset operations in the MFP 10. As described above, in the page element table 20, since in-page objects “Machine Reset”, “Network Reset”, and “Address Book & Fax Reset”, among in-page objects subordinate to the option information “Reset Menu”, are associated with the data attribute “management data”, the object display flag “display available” is set in step S52. On the other hand, since the in-page objects “All Settings Reset” and “Factory Reset” are associated with the data attribute “administrator secret data”, the object display flag “display unavailable” is set in step S52. Therefore, on the Web page 65 related to the option “Reset Menu” 67A, objects 68A, 68B, and 68C corresponding to the in-page objects “Machine Reset”, “Network Reset”, and “Address Book &Fax Reset” are displayed on a content display portion 68, and objects corresponding to the in-page objects “All Settings Reset” and “Factory Reset” become a non-display state. In other words, in a case where the sub-administrator logs in, the browser 81 displays a Web page for inputting a plurality of setting values corresponding to the second number of setting items as compared with a case where the administrator logs in, and the second number is smaller than the first number.

Upon receiving a POST request indicating that the object 68A corresponding to the in-page object “Machine Reset” in the Web page 65 shown in FIG. 13 is operated, the controller 11 restarts the MFP 10. Upon receiving a POST request indicating that the object 68B corresponding to the in-page object “Network Reset” displayed on the content display portion 68 in the Web page 65 is operated, the controller 11 restarts the communication IF 17. Upon receiving a POST request indicating that the object 68C corresponding to the in-page object “Address Book & Fax Reset” displayed on the content display portion 68 in the Web page 65 is operated, the controller 11 performs initialization of the address book and initialization of data related to FAX communication. The data also includes the setting value.

Although not displayed on the Web page 65 shown in FIG. 13, upon receiving a POST request indicating that the object corresponding to the in-page object “All Settings Reset” is operated, the controller 11 performs initialization of all data including the administrator secret data except for some setting values, for example, except for the registered administrator password. The data also includes the setting value. Upon receiving a POST request indicating that the object corresponding to the in-page object “Factory Reset” is operated, the controller 11 performs initialization of all data including the administrator secret data. The data also includes the setting value.

Next, a process in a case where the home screen 30 before the login operation is operated by using the user name “user B”, which is registered by using the account/authority management screen 50, to perform the login process will be described. As described above, in the home screen 30 before the login operation, the user name “user B” is input in the user name input field 36, the user password “xxxx2” is input in the password input field 37, and the user login button 38 is operated. At T13, the browser 81 transmits, to the MFP 10, the POST request including the user name in the user name input field 36, the password information in the password input field 37, and the information indicating that the user login button 38 is operated.

In a case where the controller 11 receives the POST request and acquires the information indicating that the user login button 38 is operated from the POST request, the controller 11 executes the login process described above in step S10. The controller 11 sets the authority flag “specific user” in step S40 of the login process. In step S11, the login process is successful (step S11: YES), and thus the process proceeds to step S12, and the controller 11 acquires all the tab information in the Web page constituting the site from the page element table 20 stored in the memory 12.

In step S15, the controller 11 executes the displayability determination process described above. In step S52 of the displayability determination process, the authority flag is the “specific user”, and thus in a case where the data attribute associated with the specified in-page object at the current time point is one of the “specific user data” and the “user data”, the controller 11 sets the object display flag “display available” for the in-page object. On the other hand, in a case where the data attribute associated with the specified in-page object at the current time point includes the “administrator secret data” and the “management data”, the controller 11 sets the object display flag “display unavailable” for the in-page object.

In this example, in the tab information “Home” specified by the variable n “1” corresponding to the tab number, the in-page objects included in the option information “Status” and “Auto Refresh Interval” are associated with the data attribute “user data”. In the tab information “Address Book” specified by the variable n “3”, in-page objects included in option information “Address”, “Import”, and “Export” are associated with the data attribute “specific user data”. On the other hand, in the tab information other than the above, in-page objects included in the option information are associated with one of the data attributes “management data” and “administrator secret data”.

Since the authority flag is the “specific user” in the process of step S52 described above, the controller 11 sets the object display flag “display available” for the in-page objects included in the option information subordinate to the tab information “Home” and “Address Book” respectively specified by the variables n “1” and “3” corresponding to the tab numbers. On the other hand, in the process of step S52, the controller 11 sets the object display flag “display unavailable” for the in-page object included in the option information subordinate to the tab information other than the tab information specified by the variables n “1” and “3”.

In the process of step S54 described above, the controller 11 sets the option display flag “display available” for the option information subordinate to the tab information “Home” and “Address Book” respectively specified by the variables n “1” and “3”. On the other hand, in the process of step S54, the controller 11 sets the option display flag “display unavailable” for the option information subordinate to the tab information other than the tab information specified by the variables n “1” and “3”.

In the process of step S17 described above, the controller 11 sets the tab display flag “display available” for the tab information “Home” and “Address Book” respectively specified by the variables n “1” and “3”. On the other hand, in the process of step S17, the controller 11 sets the tab display flag “display unavailable” for the tab information other than the tab information specified by the variables n “1” and “3”.

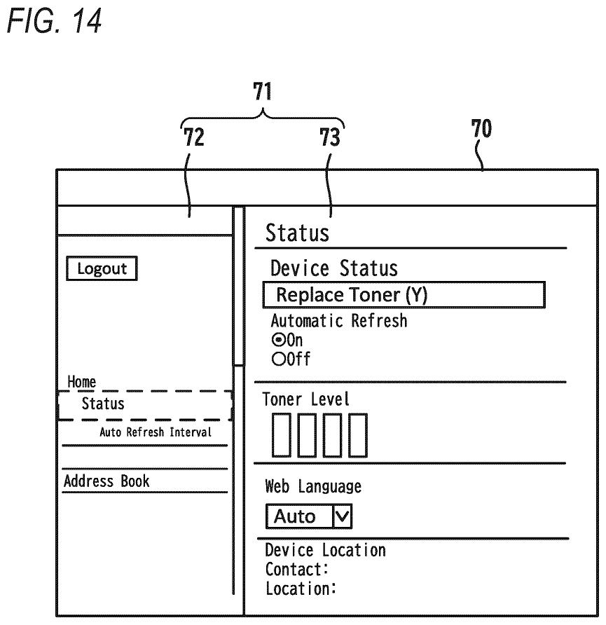

FIG. 14 illustrates a home screen 70 after the login operation, which is displayed by the browser 81 based on the Web page data created in step S20 by the controller 11, in a case where the specific user logs in. A page display field 71, a menu 72, and a content display portion 73 constituting the home screen 70 have the same configurations as the page display field 31, the menu 32, and the content display portion 33 described in FIG. 3. In this example, since the controller 11 sets the tab display flag “display available” only for the tab information “Home” and “Address Book” by the process in step S17, only the tabs “Home” and “Address Book” are displayed in the menu 72. With respect to the option information and the in-page objects subordinate to the tab information “Home” and “Address Book”, the controller 11 sets the flags to the “display available” in step S52 and step S54. Therefore, in a case where the specific user operates the tab “Address Book” displayed in the menu 72, the options “Address”, “Import”, and “Export” are displayed.

In a case where the option “Address” displayed in the menu 72 on the home screen 70 after the login operation is selected and operated, the controller 11 provides, to the PC 80, Web page data that displays a Web page for registering, in the address book, transmission destination information, which indicates a transmission destination to be used in a transmission operation of the MFP 10, according to a request from the browser 81. Here, the address book is the information stored in the memory 12, and includes a mail address that is the transmission destination information to be used for mail transmission of the scan data as an operation of the MFP 10, and a telephone number that is transmission destination information to be used for FAX transmission as an operation of the MFP 10. Upon receiving, from the browser 81, a POST request including the transmission destination information input by an operation via the Web page, the controller 11 registers the transmission destination information in the address book stored in the memory 12.

In a case where the option “Import” displayed in the menu 72 is selected and operated, the controller 11 provides, to the PC 80, Web page data that displays a Web page for importing a file in which the transmission destination information is written, according to a request from the browser 81. Storing the information included in the acquired file in the memory 12 is called Import for convenience. Upon receiving a POST request including an input file path by an operation via the Web page, the controller 11 acquires the file indicated by the file path from an external device, and registers the transmission destination information included in the acquired file to the address book registered in the memory 12.

In a case where the option “Export” displayed in the menu 72 is selected and operated, the controller 11 provides, to the PC 80, Web page data that displays a Web page for exporting the file in which the transmission destination information registered in the address book is written. Writing the information stored in the memory 12 in the file and providing the file is called Export for convenience. Upon receiving the POST request including the input file path by the operation via the Web page, the controller 11 provides the file including the transmission destination information registered in the address book of the memory 12 to the external device, according to the file path. The external device used for Import and Export may be a USB memory connected to the USB IF 18, and may be a device capable of communicating via the communication IF 17. The server and the PC 80 are examples of the device configured to communicate via the communication IF 17.

The embodiment described above can achieve the following effects.

In a case where the administrator logs in, the controller 11 of the MFP 10 receives designation of the permitted user who is permitted to perform a part of the administrator operation via an operation on the Web page displayed on the browser 81 of the PC 80. In a case where the sub-administrator or the specific user designated by the administrator logs in, the controller 11 provides, to the browser 81, Web page data that displays a Web page for receiving only the part of the administrator operation, according to a request from the browser 81. Upon receiving, from the browser 81, an instruction corresponding to the administrator operation received by the Web page for receiving the part of the administrator operation, the controller 11 executes a process corresponding to the received instruction. Accordingly, the sub-administrator or the specific user designated by the administrator can cause the MFP 10 to execute the process corresponding to the part of the administrator operation by an operation on the Web page displayed on the browser 81. As a result, it is possible to achieve both improvement in user convenience and restriction of security degradation.

The controller 11 is configured to receive designation of an administrator operation to be permitted among a plurality of administrator operations in association with the user who is designated, and in a case where any user among a plurality of permitted users logs in, the controller 11 provides, to the browser 81, Web page data that displays a Web page for receiving only the administrator operation permitted to the permitted user in a login state. Accordingly, since a part of the administrator operation to be permitted can be designated to the MFP 10, in advance, in association with the permitted user, the authority related to the administrator operation can be granted to the user within a range recognizable by the administrator.

The controller 11 can designate an administrator operation other than an operation related to the authentication information on the administrator and an operation related to the designation of the permitted user as the administrator operation to be permitted among the plurality of administrator operations. In a case where any user among the plurality of permitted users logs in, the controller 11 provides, to the browser 81, the Web page data that displays the Web page for receiving only the administrator operation permitted to the permitted user who logs in. In a case where the user other than the administrator is permitted to perform the operation related to the authentication information on the administrator and the operation related to the designation of the permitted user, the excessive reduction in security may occur, and thus the user is not permitted to the two operations.

The controller 11 can designate an operation related to the address book among the plurality of administrator operations as the administrator operation to be permitted. In a case where a user who is permitted to perform the operation related to the address book logs in among the plurality of permitted users, the controller 11 provides, to the browser 81, Web page data that displays a Web page for receiving the operation related to the address book. The user convenience is improved by allowing the user other than the administrator to perform the operation related to the address book, and thus the user is permitted to perform the operation.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the embodiment described above, the controller 11 is configured to cause the browser 81 of the PC 80 to display the Web page by the function as the Web server, and is configured to receive the designation of the permitted user by the administrator. Alternatively, the controller 11 may be configured to receive the designation of the permitted user according to an operation on the user IF 16 by the administrator. In addition, the controller 11 may be configured to receive the designation of the permitted user according to an instruction from the PC 80, without using the function of the controller 11 as the Web server.

The image forming device is not limited to the MFP 10, and may be a printing apparatus including only the printer 13.

What is claimed is:

1. An image forming device comprising:
a user interface;
a communication interface;
a controller; and
an image forming unit,
wherein the controller is configured to:
function as a Web server configured to transmit, to a browser provided in a terminal via the communication interface, Web page data for displaying a predetermined Web page, according to an instruction from the browser via the communication interface;
perform a login process of permitting a login operation performed by an administrator with respect to the image forming device, based on administrator information; and
in a case where the administrator logs in, perform, according to the administrator operation, a data providing process of providing, via the communication interface, the browser with Web page data for displaying a Web page corresponding to an administrator operation with respect to the Web page displayed by the browser,
in a case where the administrator logs in, the controller is configured to perform a designation process of receiving designation of a permitted user who is permitted to perform a part of the administrator operation, via an operation with respect to the Web page displayed on the browser,
in the data providing process, in a case where the permitted user logs in, Web page data that displays a Web page for receiving the part of the administrator operation is provided to the browser, according to a request from the browser, and
in a case where the controller receives an instruction from the browser, the instruction corresponding to the administrator operation received by the Web page for receiving the part of the administrator operation, the controller is configured to perform a process corresponding to the received instruction corresponding to the administrator operation.

2. The image forming device according to claim 1,
wherein in the designation process, the controller is configured to store, in a memory, information indicating the permitted user who is designated, and
in the data providing process, in a case where the permitted user logs in a state where the information indicating the permitted user is stored in the memory, the controller is configured to provide the browser with the Web page data that displays the Web page for receiving the part of the administrator operation.

3. The image forming device according to claim 1,
wherein in the designation process, the controller is configured to receive designation of an administrator operation to be permitted among a plurality of administrator operations, in association with the permitted user who is designated, and
in the data providing process, in a case where any user among a plurality of the permitted users logs in, the controller is configured to provide the browser with Web page data that displays a Web page for receiving only the administrator operation permitted to the permitted user in a login state.

4. The image forming device according to claim 3,
wherein in the designation process, the controller is configured to designate, as the administrator operation to be permitted among the plurality of administrator operations, an administrator operation other than an operation related to authentication information on the administrator and an operation related to the designation of the permitted user, and
in the data providing process, in a case where any user among the plurality of permitted users logs in, the controller is configured to provide the browser with the Web page data that displays the Web page for receiving only the administrator operation permitted to the permitted user who logs in.

5. The image forming device according to claim 3,
wherein in the designation process, the controller is configured to designate, as the administrator operation to be permitted among the plurality of administrator operations, an operation related to an address book, among the plurality of administrator operations, and
in the data providing process, in a case where a user who is permitted to perform the operation related to the address book among the plurality of permitted users logs in, the controller is configured to provide the browser with Web page data that displays a Web page for receiving the operation related to the address book.

6. The image forming device according to claim 1,
wherein in the data providing process:
in a case where the administrator logs in, the controller is configured to provide the browser with respective Web page data that displays the first number of Web pages for inputting a setting value, as a Web page for receiving only the administrator operation; and
in a case where the permitted user logs in, the controller is configured to provide the browser with respective Web page data that displays the second number of Web pages, as the plurality of Web pages for inputting the setting value, the second number being smaller than the first number.

7. The image forming device according to claim 6,
wherein in the data providing process:
in a case where the administrator logs in, the controller is configured to provide the browser with Web page data that includes a link to the first number of Web pages to provide the browser with the Web page data that displays the first number of Web pages; and
in a case where the permitted user logs in, the controller is configured to provide the browser with Web page data including a link to the second number of Web pages to provide the browser with the Web page data that displays a plurality of Web pages that is the second number of Web pages.

8. The image forming device according to claim 1,
wherein in the data providing process:
in a case where the administrator logs in, the controller is configured to provide the browser with Web page data that displays a Web page for inputting a plurality of setting values corresponding to the first number of setting items, as a Web page for receiving only the administrator operation, and
in a case where the permitted user logs in, the controller is configured to provide the browser with Web page data that displays a Web page for inputting a plurality of setting values corresponding to the second number of setting items, the second number being smaller than the first number.

9. An image forming device comprising:
a user interface;
a communication interface;
a controller; and
an image forming unit,
wherein the controller is configured to:
perform a login process of permitting a login operation performed by an administrator with respect to the image forming device, based on administrator information; and
in a case where the administrator logs in, perform, according to the administrator operation, a data providing process of providing, via the communication interface, a browser of a terminal with Web page data for displaying a Web page corresponding to an administrator operation with respect to a Web page displayed by the browser,
in a case where the administrator logs in, the controller is configured to perform a designation process of receiving designation of a permitted user who is permitted to perform a part of the administrator operation, via an operation with respect to the Web page displayed on the browser, and of storing information indicating the permitted user who is designated in a memory,
in the data providing process, in a case where the permitted user logs in a state where the information indicating the permitted user is stored in the memory, Web page data that displays a Web page for only receiving the part of the administrator operation is provided to the browser, according to a request from the browser, and
in a case where the controller receives an instruction from the browser, the instruction corresponding to the administrator operation received by the Web page for receiving the part of the administrator operation, the controller is configured to perform a process corresponding to the received instruction corresponding to the administrator operation.

10. The image forming device according to claim 9,
wherein in the designation process, the controller is configured to receive designation of an administrator operation to be permitted among a plurality of administrator operations, in association with the permitted user who is designated, and
in the data providing process, in a case where any user among a plurality of the permitted users logs in, the controller is configured to provide the browser with Web page data that displays a Web page for receiving only the administrator operation permitted to the permitted user in a login state.

11. The image forming device according to claim 10,
wherein in the designation process, the controller is configured to designate, as the administrator operation of which reception is to be permitted among the plurality of administrator operations, an administrator operation other than an operation related to authentication information on the administrator and an operation related to the designation of the permitted user, and
in the data providing process, in a case where any user among the plurality of permitted users logs in, the controller is configured to provide the browser with the Web page data that displays the Web page for receiving only the administrator operation permitted to the permitted user who logs in.

12. The image forming device according to claim 10,
wherein in the designation process, the controller is configured to designate, as the administrator operation to be permitted among the plurality of administrator operations, an operation related to an address book among the plurality of administrator operations, and
in the data providing process, in a case where a user who is permitted to perform the operation related to the address book among the plurality of permitted users logs in, the controller is configured to provide the browser with Web page data that displays a Web page for receiving the operation related to the address book.

13. The image forming device according to claim 9,
wherein in the data providing process:
in a case where the administrator logs in, the controller is configured to provide the browser with the first number of pieces of Web page data that displays respective Web pages for inputting a setting value, as a Web page for receiving only the administrator operation; and
in a case where the permitted user logs in, the controller is configured to provide the browser with respective Web page data that displays the second number of Web pages among the Web pages for inputting the setting value, as the Web page for receiving the part of the administrator operation, the second number being smaller than the first number.

14. The image forming device according to claim 13,
wherein in the data providing process:
in a case where the administrator logs in, the controller is configured to provide the browser Web page data that includes a link to the first number of pieces of Web page data to provide the browser with Web page data that displays the first number of Web pages; and
in a case where the permitted user logs in, the controller is configured to provide the browser with Web page data including a link to the second number of pieces of Web page data to provide the browser with the Web page data that displays a plurality of Web pages that is the second number of Web pages.

15. The image forming device according to claim 9,
wherein in the data providing process:
in a case where the administrator logs in, the controller is configured to provide the browser with Web page data that displays a Web page for inputting a plurality of setting values corresponding to the first number of setting items, as a Web page for receiving only the administrator operation; and
in a case where the permitted user logs in, the controller is configured to provide the browser with Web page data that displays a Web page for inputting a plurality of setting values corresponding to the second number of setting items, as the Web page for receiving the part of the administrator operation, the second number being smaller than the first number.

16. An image forming device comprising:
a user interface;
a communication interface;
a controller; and
an image forming unit,
wherein the controller is configured to:
perform a login process of permitting a login operation performed by an administrator with respect to the image forming device, based on administrator information; and
in a case where the administrator logs in, perform, according to the administrator operation, a data providing process of providing, via the communication interface, a browser of a terminal with Web page data for displaying a Web page corresponding to an administrator operation with respect to a Web page displayed by the browser,
the controller is configured to perform a designation process of receiving designation of a permitted user who is permitted to perform a part of the administrator operation, via an operation with respect to the Web page displayed on the browser, and of receiving an operation of designating whether any administrator operation among a plurality of the administrator operations is permitted, in association with the permitted user who is designated,
in the data providing process, in a case where the permitted user logs in, Web page data that displays a Web page for receiving the part of the administrator operation is provided to the browser, according to a request from the browser,
in a case where the controller receives an instruction from the browser, the instruction corresponding to the administrator operation received by the Web page for receiving the part of the administrator operation, the controller is configured to perform a process corresponding to the received instruction corresponding to the administrator operation, and
in the data providing process, in a case where the Web page data for receiving only the part of the administrator operation is provided, the controller is configured to determine to use a first method or a second method, based on the permitted user who logs in among a plurality of the permitted users, a method for providing Web page data for receiving only the part of the administrator operation including the first method and the second method.

17. The image forming device according to claim 16,
wherein in the data providing process:
in a case where the administrator logs in, the controller is configured to provide the browser with respective Web page data that displays the first number of Web pages for inputting a setting value, as a Web page for receiving only the administrator operation; and
as the first method, the controller is configured to provide the browser with respective Web page data that displays the second number of Web pages, as the plurality of Web pages for inputting the setting value, the second number being smaller than the first number.

18. The image forming device according to claim 16,
wherein in the data providing process:
in a case where the administrator logs in, the controller is configured to provide the browser with Web page data that displays a Web page for inputting a plurality of setting values corresponding to the first number of setting items, as the Web page for receiving only the administrator operation, and
as the second method, the controller is configured to provide the browser with Web page data that displays a Web page for inputting a plurality of setting values corresponding to the second number of setting items, the second number being smaller than the first number.
